(19) United States
(12) Patent Application Publication
(10) Pub. No.: US 2015/0213002 A1
(43) Pub. Date: Jul. 30, 2015

(54) PERSONAL EMOTION STATE MONITORING FROM SOCIAL MEDIA

(71) Applicant: International Business Machines Corporation, Armonk, NY (US)

(72) Inventors: Liang Gou, San Jose, CA (US); Fei Wang, San Jose, CA (US); Jian Zhao, Toronto (CA); Michelle X. Zhou, Saratoga, CA (US)

(73) Assignee: International Business Machines Corporation, Armonk, NY (US)

(21) Appl. No.: 14/162,798

(22) Filed: Jan. 24, 2014

(51) Int. Cl. G06F 17/27

(52) U.S. Cl. CPC G06F 17/2785

(57) ABSTRACT

Embodiments relate to monitoring personal emotion states over time from social media. One aspect includes extracting personal emotion states from at least one social media data source using a semantic model including an integration of numeric emotion measurements and semantic categories. Timeline based emotion segmentation with consistent emotional semantics is performed based on the semantic model. In a visual interface, interactive visual analytics are provided to explore and monitor personal emotional states over time including both a numeric and semantic interpretation of emotions with visual encodings. Visual evidence for analytical reasoning of emotion is also provided.

### BACKGROUND

The present disclosure relates generally to social media based analytics, and more specifically, to a system for monitoring personal emotion states over time from social media.

Personal emotions, such as anger, joy, and grief, have significant impacts on people's outer performance and actions, such as decision making. Tracing and analyzing of personal emotions can have great value in many application domains. One such example is personalized customer care. For instance, a customer representative can attempt to monitor a customer's emotion status when serving a customer. The customer representative may better know when to deliver special care if changes in emotion of the customer are highlighted.

With the popularity of online social media such as microblogs, people leave a wealth of public digital footprints with their comments, opinions, and ideas. Therefore, the corresponding growth of available emotional text makes it possible to capture people's consciousness and affective states in a moment-to-moment manner.

However, the analysis of emotion remains challenging, because the data are often noisy, large, and unstructured, and analytical models may not always be reliable. Interactive visualization can facilitate analytical reasoning of data by integrating human knowledge into the process. Many examples have demonstrated efficiency in social media analysis. Nonetheless, present social media analysis techniques are typically focused on coarse-level sentiment analysis (i.e., positive or negative affective states) and/or lack adequate fine-grained emotion information from multiple perspectives.

### SUMMARY

Embodiments include a method, system, and computer program product for monitoring personal emotion states over time from social media. The method includes extracting personal emotion states from at least one social media data source using a semantic model including an integration of numeric emotion measurements and semantic categories. Timeline based emotion segmentation with consistent emotional semantics is performed based on the semantic model. In a visual interface, interactive visual analytics are provided to explore and monitor personal emotional states over time including both a numeric and semantic interpretation of emotions with visual encodings. Visual evidence for analytical reasoning of emotion is also provided.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the disclosure are apparent from the following detailed description taken in conjunction with the accompanying drawings in which:

FIG. 1 depicts a system for practicing the teachings herein, in accordance with an embodiment;

FIG. 2 depicts an example formation of a semantic model in accordance with an embodiment;

FIG. 3 depicts an example refinement of a semantic model in accordance with an embodiment;

FIG. 4 depicts a visual interface in accordance with an embodiment;

FIG. 5 depicts a visual interface illustrating a split of emotion bands in accordance with an embodiment;

FIG. 6 depicts a visual interface illustrating highlighted emotion patterns in accordance with an embodiment;

FIGS. 7A-7C depict various keyword and emotion views in accordance with an embodiment;

FIG. 8 depicts a process flow for monitoring personal emotion states over time from social media in accordance with an embodiment; and

FIG. 9 depicts a processing system for practicing the teachings herein, in accordance with an embodiment.

### DETAILED DESCRIPTION

Embodiments described herein are directed to methods, systems and computer program products for monitoring personal emotion states over time from social media. Exemplary embodiments include a system designed to interactively illustrate emotion patterns of a person over time and offer visual evidence for emotion states from social media text. The system can generate emotion segments over time from social media based on a semantic model that includes an integration of numeric emotion measurements and semantic categories. The system may visually encode and summarize personal emotion segments from multiple perspectives based on the semantic model. The system can use a visual metaphor to unfold emotion patterns along timeline. The system may also provide visual evidence for reasoning how emotions are derived with emotion words, social media data, and summarized tag clouds.

Technical effects include visually enabling a fine-grained understanding of an individual's emotion based on a semantic model that includes an integration of numeric emotion measurements and semantic categories. Embodiments enable detection of emotion styles with time band visualization. Visual reasoning can indicate how emotion states are generated from social media data.

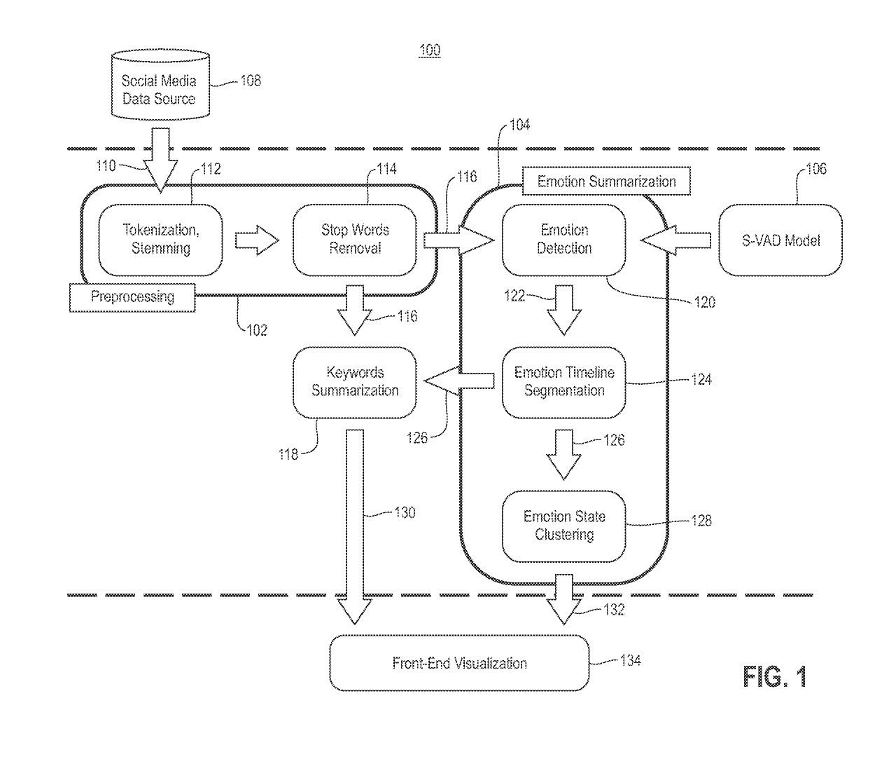

Referring now to FIG. 1, a system 100 for monitoring personal emotion states over time from social media, according to one embodiment, is illustrated. The system 100 includes preprocessing logic 102, emotion summarization logic 104, and a semantic model 106. The preprocessing logic 102 receives social media data 110 from at least one social media data source 108, for example, over a network such as the Internet. The social media data source 108 can store raw text and meta-data for a large number of selected users. When a user initiates a query with a particular identifier, all the social media data 110, such as “tweets”, for that identifier are gathered from the social media data source 108 and forwarded to the preprocessing logic 102. The social media data 110 can include sentences of words, timestamps, links, and other information.

The preprocessing logic 102 performs tokenization and stemming 112 of the social media data 110 and stop word removal 114 to extract and reduce words from the social media data 110. A reduced social media word set 116 is provided to the emotion summarization logic 104 and keyword summarization 118. Emotion detection 120 is performed by the emotion summarization logic 104 on the reduced social media word set 116 using the semantic model 106 to extract personal emotion states 122. In an embodiment, the semantic model 106 is an integration of numeric emotion measurements and semantic categories, for instance, a combined valance (or pleasure), arousal, dominance (VAD) emotion model and an emotion category model as further described herein.

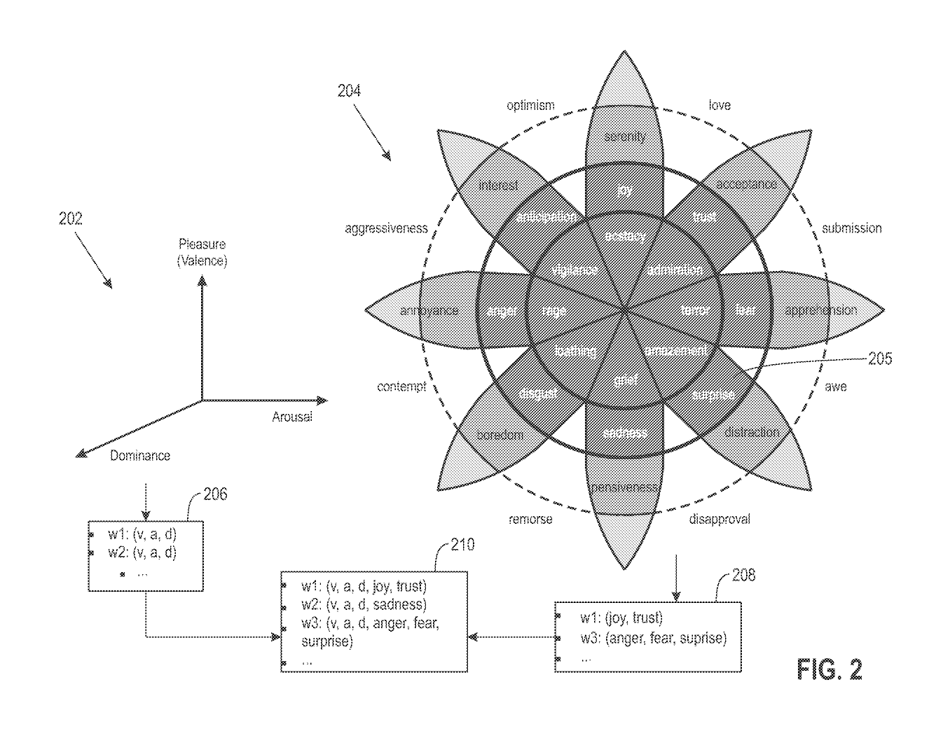

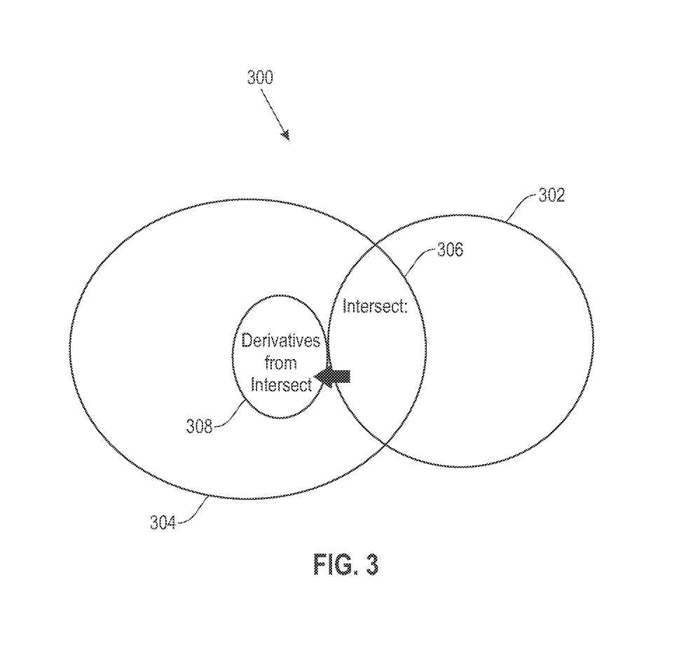

For each sample of the social media data 110, e.g., each “tweet”, lexicon-based (e.g., dictionary-based) emotions are calculated according to at least two models that collectively form the semantic model 106. For example, a VAD emotion model can be based on pleasure, arousal and dominance (PAD) dimensions of a PAD or VAD model as known in the art. Alternatively or additionally, a circumplex model can be used where emotions are distributed in a two-dimensional circular pace of arousal or valence/pleasure. An example of an emotion category model is known in the art as Plutchik's model that defines eight basic emotions or moods. One exemplary method of extracting and defining words for emotion detection is as follows. Let sᵢ be the ith mood in an emotion category model. Nᵢ denotes the number of occurrences of emotional words for mood sᵢ (based on the lexicon), and N denote the total number of words in a sample (e.g., a “tweet”) of the social media data 110. Thus, the score mᵢ for emotional mood sᵢ is then Nᵢ/N. Repeating or sharing of data from another user can be excluded when computing such lexicon-based emotion, since the words are generated by another user. A dimensional representation of emotion can be estimated by averaging valence, arousal and dominance values (the PAD model) of the emotional words in that appeared in the lexicon. Therefore, the emotion information can be represented by two emotion score vectors, including: an emotion category model vector M: (m₁, m₂, . . . , m₈) and a PAD/VAD emotion model vector P: (v, a, d). Further details are provided herein with respect to FIGS. 2 and 3.

FIG. 2 depicts an example formation of a semantic model in accordance with an embodiment, such as the semantic model 106 of FIG. 1. A valance, arousal, dominance (VAD) emotion model 202 and an emotion category model 204 provide different organizational formats to quantify emotions. The VAD emotion model 202 can define emotion relative to three axes (valence/pleasure, arousal, and dominance) as numerical values. The emotion category model 204 can define eight basic emotions 205 at different levels of intensity. In the example of FIG. 2, the eight basic emotions 205 are also referred to as moods 205 and include: joy, trust, fear, surprise, sadness, disgust, anger, and anticipation. Other emotions can be defined as a combination of the eight basic emotions 205. Separate lexicons (dictionaries) can be defined relative to each model. For example, emotion combinations from the VAD emotion model 202 form a first lexicon 206, and emotion combinations from the emotion category model 204 form a second lexicon 208. The first and second lexicons 206 and 208 can be mapped to form a semantic VAD emotion model 210. As can be seen in the example of FIG. 2, the first lexicon 206 can include words, such as w2, that are not defined in the second lexicon 208, and the second lexicon 208 can include words, such as w3, that are not defined in the first lexicon 206. A synonym lookup or other lookup process can be used to identify similar words in the first and second lexicons 206 and 208 to derive VAD/PAD scores or emotion categories for non-intersecting values between the first and second lexicons 206 and 208 when forming the semantic VAD emotion model 210. One such example is further described in reference to FIG. 3.

FIG. 3 depicts an example refinement 300 of a semantic model in accordance with an embodiment. For instance, the semantic model 106 of FIG. 1 or the semantic VAD emotion model 210 of FIG. 2 may be developed and refined according to the example of FIG. 3. In the example of FIG. 3, a first lexicon 302 includes a first number of words and represents an embodiment of the first lexicon 206 of FIG. 2. A second lexicon 304 can include a second number of words and represents an embodiment of the second lexicon 208 of FIG. 2. For instance, the first lexicon 302 can be based on a known affective norms for English words (ANEW) dictionary that provides normative emotional ratings of a large number of words in terms of pleasure, arousal, and dominance. The second lexicon 304 can be based on a known national research council (NRC) emotion lexicon that is based on eight basic moods. An intersection 306 of the first and second lexicons 302 and 304 represents a common subset of words. Further derivatives 308 from the intersection 306 can be developed. Binary classifiers can be built for each emotion category of the emotion category model 204 of FIG. 2 based on numeric values of the VAD emotion model 202 of FIG. 2, and the binary classifiers can be used to predict a basic emotion category. Words with unknown VAD scores are identified, and synonyms with known VAD scores that correspond to each of the words with unknown VAD scores are determined. A VAD score can be assigned to each of the words with unknown VAD scores based on an average VAD score of corresponding synonyms. Manual inspection of results can be used to ensure that synonyms reflect the same emotion but with different levels of arousal, e.g., “fury” and “anger”.

Returning to FIG. 1, the emotion summarization logic 104 also includes emotion timeline segmentation 124 that can perform timeline based emotion segmentation of the personal emotion states 122 with consistent emotional semantics based on the semantic model 106. A segmented emotion timeline 126, also referred to generally as a timeline 126, is provided to the keyword summarization 118 and to emotion state clustering 128 of the emotion summarization logic 104. The emotion timeline segmentation 124 groups data based on similarity in both time and emotion dimensions. The emotion timeline segmentation 124 can define an emotion distance between the personal emotion states 122 as a weighted sum of a category score and a VAD score. The weighted sum of the category score and the VAD score can include a normalization factor to balance contributions of different emotion representations. For example, emotion distance between social media expressions including personal emotion states 122 at different times (T₁ and T₂) can be expressed as equation (1).

D_{E}(T₁,T₂)=α₁∥M₁−M₂∥₂+α₂∥P₁−P₂∥₂ (1)

In equation (1), α₁ and α₂ are normalization factors which balance the contribution of two scores of different emotion representations. Mᵢ and Pᵢ are emotion score vectors of social media expressions at different times Tᵢ respectively. The emotion timeline segmentation 124 may search a timeline to identify a top-n number of longest emotion distance scores and apply n cuts at time points along the timeline with the top-n number of longest emotion distance scores, thereby grouping similar instances of the personal emotion states 122 together along the timeline.

The emotion state clustering 128 can further identify groups of similar personal emotion states 122 as emotion state clusters 132. The emotion state clustering 128 can remove minor and outlier emotions while preserving the dominant ones. Clustering can be performed as hierarchical clustering using an “agglomerative” method, also known as a “bottom up” approach, where each data point starts in its own cluster, and pairs of clusters are merged as moving up in the hierarchy. Following this approach, all emotional words within a time segment can initially form eight clusters based on the eight mood labels from the eight basic emotions 205, note that some clusters may be empty. Clusters having centers close to each other in the three-dimensional PAD/VAD space of the VAD emotion model 202 of FIG. 2 can be merged, and the mood label reassigned to the merged cluster according to the relative distance between the new center and the original one. For example, if two clusters “disgust” and “anger” are about to be merged, all the words in those two moods are combined together and the average PAD scores recomputed, which is a new cluster center in the PAD/VAD space. If this new center is closer to the original “disgust” cluster than the “anger” one, this new cluster is assigned as “disgust”. In the end, only clusters containing relatively large numbers of emotional words are retained and the smaller ones are discarded. The number of words in each remaining cluster can be normalized to represent the mood intensity.

This results in emotion data for the visual interface 134 and can include a series of emotion states Eₜ for each time segment (where t=1 . . . n and n is the number of segments), containing the overall and mood-specific valence, arousal and dominance scores in the VAD emotion model 202 of FIG. 2 as well as the intensity values of the eight basic emotions 205 of FIG. 2 from the emotion category model 204 of FIG. 2. Although described relative to the eight basic emotions 205 of FIG. 2, it will be understood that an additional or a reduced number of emotion categories can be used.

Summarized keywords 130 from keyword summarization 118 and the emotion state clusters 132 from the emotion state clustering 128 can be provided to a visual interface 134. Timestamps in the social media data 110 can be used for time segmentation and establishing boundaries for frequency based analysis. To summarize the content within a time segment for providing low-level data evidence, term frequency-inverse document frequency (tf-idf) scores can be computed in the keyword summarization 118 for all words in the social media data 110, excluding stop words. Words in each time segment can be considered a “document” for calculating an inverse document frequency for the words. The tf-idf model can be used instead of an established topic-base model since it is fast and does not require any training process, which can be critical for microblogs where the contents are updated constantly along a timeline. Only words with scores above a certain threshold may be selected for representing the content as keywords in the time segment. Such information, keywords and their scores, can also be fed as summarized keywords 130 to the visual interface 134 for visualization along with the emotion data from the emotion state clusters 132.

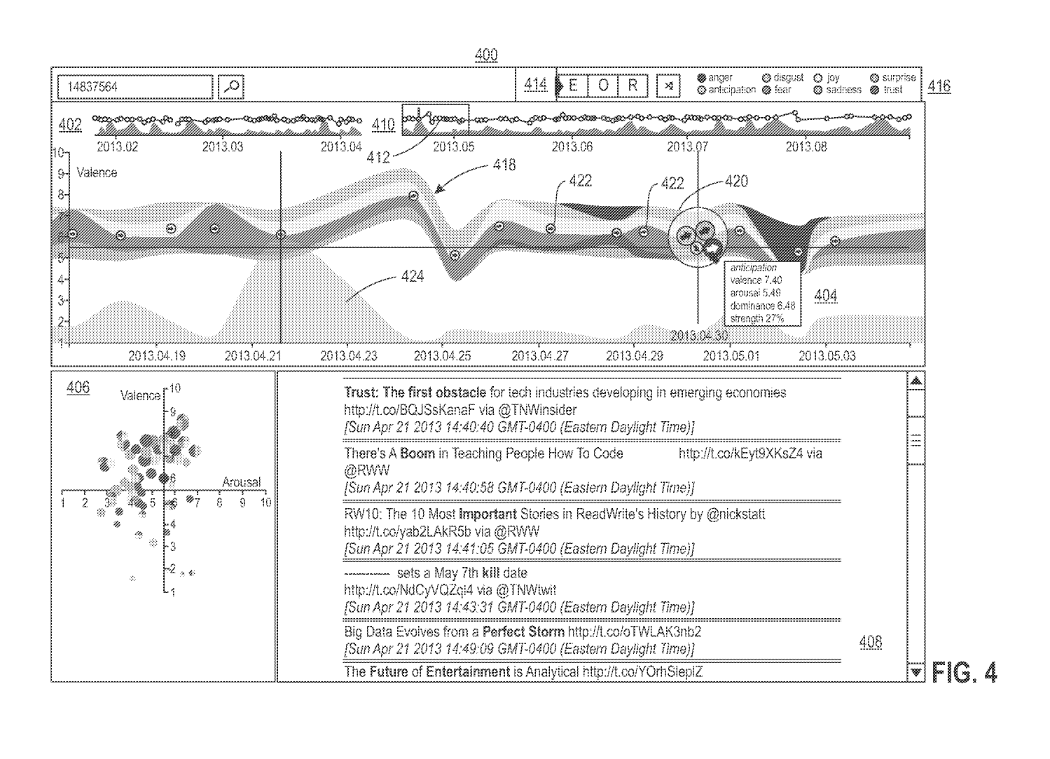

The visual interface 134 provides a front-end interface for users to explore a number of visualizations related to personal emotion states 122. The visual interface 134 is described in further detail herein with respect to FIGS. 4-7.

FIG. 4 depicts a visual interface 400 in accordance with an embodiment as a graphical example of displayed content on the visual interface 134 of FIG. 1. The visual interface 400 of FIG. 4 can include an emotion overview 402, an emotion detail view 404, an emotional words view 406, and a social media content view 408. A time window 410 show emotion timelines 412 at a finer level. The visual interface 400 illustrates a person's emotion history with emotion bands 418. Emotion bubbles 420 can be displayed when a user interface pointer hovers over a particular emotion state, including information such as emotion category, VAD values, and strength or intensity. When displaying emotion bands 418, the vertical axis represents overall valence Vₜ along the emotion timeline, where the score can range from 1 to 10, bottom to top. An arousal scale Aₜ can be displayed by the brightness of colors on emotion bands 418, with darker color implying lower arousal level. Dominance of emotions Dₜ can be represented by the orientation of an arrow at each emotion state data point 422 on the emotion bands 418. Downward pointing arrows indicate more submissive emotions, whereas upward pointing arrows indicate more dominant emotions. Eight basic moods Mₜ, that form the general emotion can be encoded with hues of emotion bands 418, and mood intensity levels are normalized and mapped to the band heights at each time-stamp, i.e., such that band height is substantially constant. Smoothing interpolation can be used along the timeline between emotion state data points 422. Arousal and dominance of moods, aₜᵢ and dₜᵢ, can be encoded with color brightness and arrow orientation; and the hue and size of each bubble can be used to represent the category and intensity of mood.

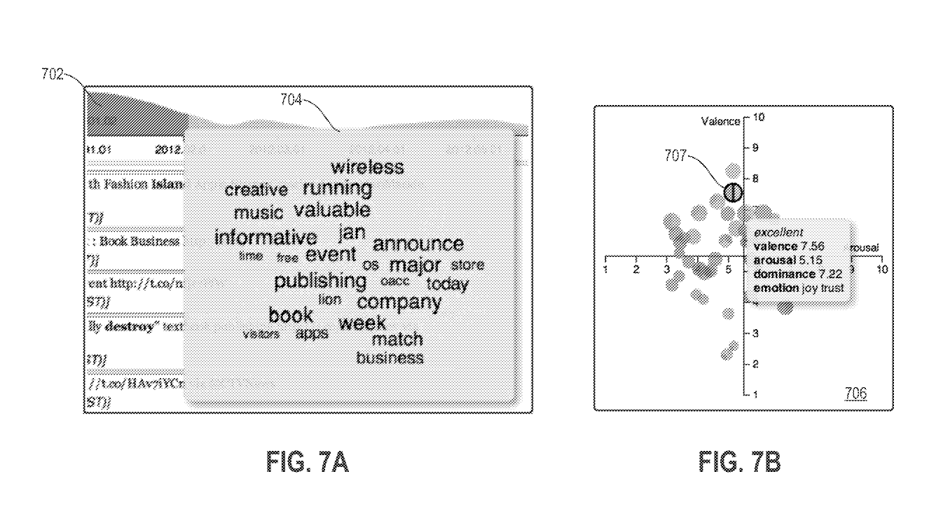

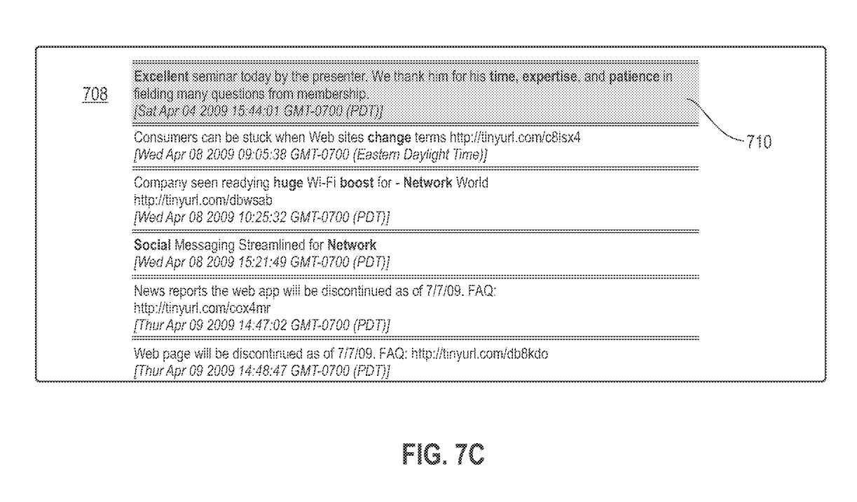

Further manipulations of the visual interface 400 can be performed using operational buttons 414 and an interactive legend 416. In the example of FIG. 4, emotions can be classified according to the interactive legend 416 as anger, anticipation, disgust, fear, joy, sadness, surprise, and trust. The interactive legend 416 can be used to enable display of selected emotions or filter out emotions from being displayed. Other information, such as social media data volume 424 can also be graphically depicted as part of the emotion overview 402 and emotion detail view 404. Further details regarding the emotional words view 406 and social media content view 408 are provided in the examples of FIGS. 7B-7C as further described herein.

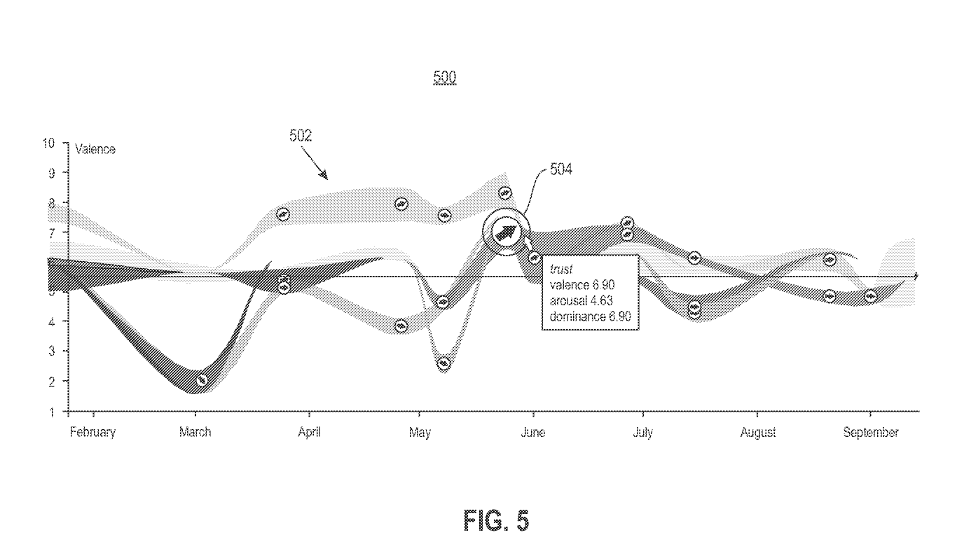

FIG. 5 depicts a visual interface 500 illustrating a split of emotion bands 502 in accordance with an embodiment. The x-axis represents time and the y-axis indicates emotion valence. Each emotion that is tracked and displayed in emotion bands 502 can have a different color or pattern. The thickness of each emotion band 502 indicates emotion category proportion. Differing levels of brightness in the emotion bands 502 can indicate different levels of emotion arousal. Splitting the aggregated emotion bands 502 enables exploration of detail timelines of individual moods, where a band position and color brightness correspond to the valence and arousal of each mood (vₜᵢ and aₜᵢ). Accordingly, every emotion state on the emotion bands 502 is divided into several states with arrow orientation representing dominance scores dₜᵢ for each mood. In this mode, hovering over a separated emotion state can display an associated emotion bubble 504 split from the packed layout of FIG. 4. This allows the exploration of variations for both overall emotions and detail mood components in time. From the aggregated view of FIG. 4, users can identify patterns of personal emotion history as a whole, such as “what are the general emotion highs and lows”, and with the split view of FIG. 5, users can trace the changes of each mood individually, such as “how is one's angriness during a period of time”.

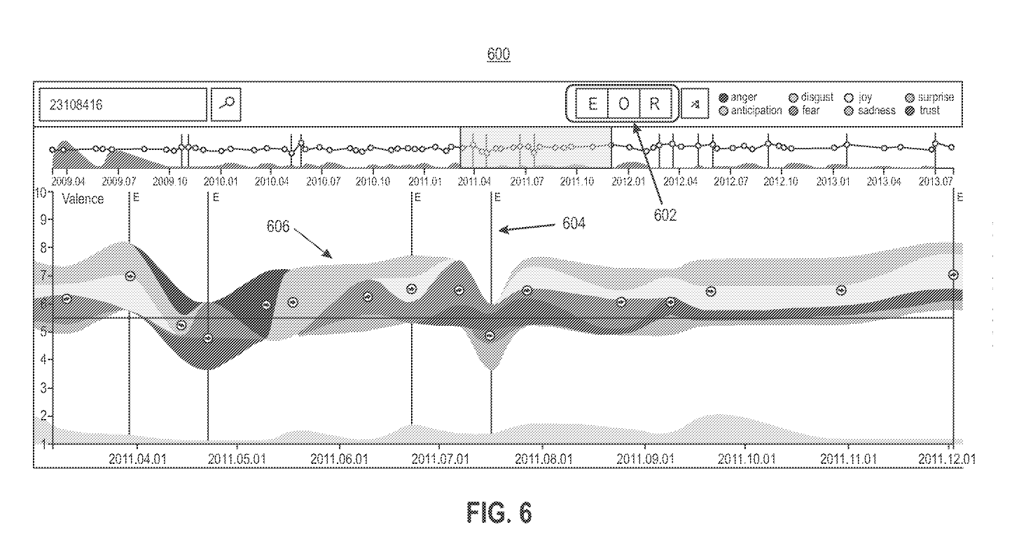

FIG. 6 depicts a visual interface 600 illustrating highlighted emotion patterns in accordance with an embodiment. Operational buttons 602 are examples of the operational buttons 414 of FIG. 4 and can be used to highlight emotion patterns of extreme emotion, emotion outlook and emotion resilience. For example, upon selecting operational button “E”, extreme emotion patterns 604 are highlighted on emotion bands 606. The extreme emotion patterns 604 can represent outlier points that deviate greater than a threshold amount from an average value. An emotion outlook period can highlight periods of time having emotional stability. An emotion resilience state can highlight transitions from negative to positive emotions. Other known patterns can also be included for visual highlighting in embodiments.

FIGS. 7A-7C depict various keyword and emotion views in accordance with an embodiment. FIG. 7A is an example of displaying the summarized keywords 130 of FIG. 1 based on hovering a user interface pointer over a specific time segment 702 of the social media data volume 424 of FIG. 4. The hovering may initiate display of a tag-cloud tooltip 704 summarizing important keywords from the text.

When a user is interested in a particular emotion state, the user can select a corresponding object on the emotion bands 418 of FIG. 4, and detail information with highlights of data evidence for deriving the emotions can be shown in the emotional words view 406 and social media content view 408 of FIG. 4. An emotional words view 706 of FIG. 7B is an example of the emotional words view 406 of FIG. 4 with the word “excellent” highlighted. The emotional words view 706 displays a scatter-plot of words identified from, for example, the first and second lexicons 206 and 208 of FIG. 2 in the social media data 110 of FIG. 1. The emotional words view 706 can display words as small circles in a valence-arousal two-dimension space, where the radius represents the dominance score and the filled colors indicate the associated moods. Thus the user is able to identify clusters of words with similar emotion aspects, which indicates how the current emotion state is derived from the social media data 110 of FIG. 1.

A social media content view 708 of FIG. 7C is an example of the social media content view 408 of FIG. 4, where the emotional words are emphasized in coordination with the emotional words view 706 of FIG. 7B. Dynamic brushing and linking techniques can be applied for interactively coordinating visualizations displayed among different views. For example, hovering a user interface pointer over a particular item 707 in the emotional words view 706 may automatically scroll the social media content view 708 to display an associated sample of social media data 710, e.g. a “tweet”, and selecting the item 707 can highlight the associated sample of social media data 710. The same mechanisms are also applied in the other direction from the social media content view 708 to the emotional words view 706. Linking between views can be initiated by moving a user interface pointer over emotion bubbles of a selected state.

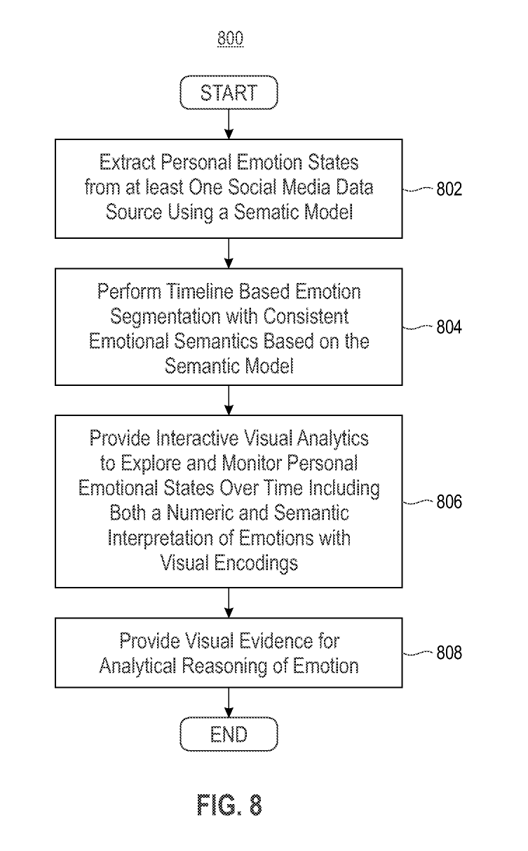

Referring now to FIG. 8, a process flow of a method 800 for monitoring personal emotion states over time from social media in accordance with an embodiment is illustrated. FIG. 8 is further described in reference to FIGS. 1-7. In this embodiment, a method 800 includes, at block 802, extracting personal emotion states 122 from at least one social media data source 108 using a semantic model 106 including an integration of numeric emotion measurements and semantic categories, for example, from lexicons 206 and 208 of FIG. 2. The semantic model 106 can include a combined valance, arousal, dominance (VAD) emotion model 202 and an emotion category model 204. The semantic model 106 can be built using a classifier for each emotion category in the emotion category model 204 based on numeric values of the VAD emotion model 202 to predict a basic emotion category.

At block 804, timeline based emotion segmentation with consistent emotional semantics is performed based on the semantic model 106. Timeline based emotion segmentation can include defining an emotion distance between the personal emotion states 122 as a weighted sum of a category score and a VAD score. A timeline can be searched to identify a top-n number of longest emotion distance scores. A number n cuts can be applied at time points along the timeline with the top-n number of longest emotion distance scores, thereby grouping similar instances of the personal emotion states 122 together along the timeline. The weighted sum of the category score and the VAD score can include a normalization factor to balance contributions of different emotion representations.

At block 806, interactive visual analytics are provided in visual interface 134 to explore and monitor personal emotional states 122 over time including both a numeric and semantic interpretation of emotions with visual encodings. At block 808, visual evidence for analytical reasoning of emotion at different levels of detail is provided. Visual evidence for analytical reasoning of emotion at different levels can include one or more of: text summarization, emotion word and original text context view. Providing visual evidence for analytical reasoning of emotion at different levels may include providing visual clues to show an emotional style. Emotional style may include one or more of: an emotion outlook, an extreme emotion, and emotion resilience.

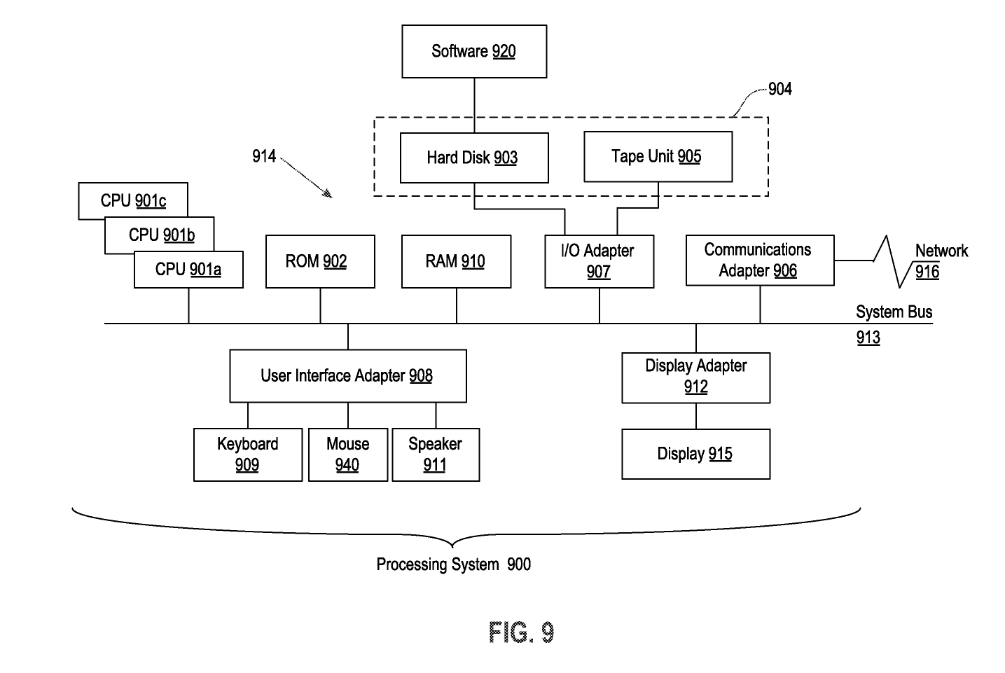

Referring now to FIG. 9, there is shown an embodiment of a processing system 900 for implementing the teachings herein. In this embodiment, the processing system 900 has one or more central processing units (processors) 901a, 901b, 901c, etc. (collectively or generically referred to as processor(s) 901). Processors 901 are coupled to system memory 914 and various other components via a system bus 913. Read only memory (ROM) 902 is coupled to system bus 913 and may include a basic input/output system (BIOS), which controls certain basic functions of the processing system 900. The system memory 914 can include ROM 902 and random access memory (RAM) 910, which is read-write memory coupled to system bus 913 for use by processors 901.

FIG. 9 further depicts an input/output (I/O) adapter 907 and a network adapter 906 coupled to the system bus 913. I/O adapter 907 may be a small computer system interface (SCSI) adapter that communicates with a hard disk 903 and/or tape storage drive 905 or any other similar component. I/O adapter 907, hard disk 903, and tape storage drive 905 are collectively referred to herein as mass storage 904. Software 920 for execution on processing system 900 may be stored in mass storage 904. Network adapter 906 interconnects system bus 913 with an outside network 916 enabling processing system 900 to communicate with other such systems. A screen (e.g., a display monitor) 915 is connected to system bus 913 by display adapter 912, which may include a graphics controller to improve the performance of graphics intensive applications and a video controller. In one embodiment, adapters 907, 906, and 912 may be connected to one or more I/O buses that are connected to system bus 913 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 913 via user interface adapter 908 and display adapter 912. A keyboard 909, mouse 940, and speaker 911 can be interconnected to system bus 913 via user interface adapter 908, which may include, for example, a Super I/O chip integrating multiple device adapters into a single integrated circuit.

Thus, as configured in FIG. 9, processing system 900 includes processing capability in the form of processors 901, and, storage capability including system memory 914 and mass storage 904, input means such as keyboard 909 and mouse 940, and output capability including speaker 911 and display 915. In one embodiment, a portion of system memory 914 and mass storage 904 collectively store an operating system such as the AIX® operating system from IBM Corporation to coordinate the functions of the various components shown in FIG. 9.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of monitoring personal emotion states over time from social media, the method comprising:
extracting personal emotion states from at least one social media data source using a semantic model comprising an integration of numeric emotion measurements and semantic categories;
performing timeline based emotion segmentation with consistent emotional semantics based on the semantic model;
providing, in a visual interface, interactive visual analytics to explore and monitor personal emotional states over time including both a numeric and semantic interpretation of emotions with visual encodings; and
providing visual evidence for analytical reasoning of emotion.

2. The method of claim 1, wherein the semantic model further comprises a combined valance, arousal, dominance (VAD) emotion model and an emotion category model.

3. The method of claim 2, wherein the semantic model is built using a classifier for each emotion category in the emotion category model based on numeric values of the VAD emotion model to predict a basic emotion category, and further comprising:
identifying words with unknown VAD scores;
determining synonyms with known VAD scores that correspond to each of the words with unknown VAD scores; and
assigning a VAD score to each of the words with unknown VAD scores based on an average VAD score of corresponding synonyms.

4. The method of claim 2, wherein performing timeline based emotion segmentation further comprises:
defining an emotion distance between the personal emotion states as a weighted sum of a category score and a VAD score;
searching a timeline to identify a top-n number of longest emotion distance scores; and
applying n cuts at time points along the timeline with the top-n number of longest emotion distance scores, thereby grouping similar instances of the personal emotion states together along the timeline.

5. The method of claim 4, wherein the weighted sum of the category score and the VAD score includes a normalization factor to balance contributions of different emotion representations.

6. The method of claim 1, wherein providing visual evidence for analytical reasoning of emotion includes one or more of: text summarization, emotion word and original text context view.

7. The method of claim 1, wherein providing visual evidence for analytical reasoning of emotion further comprises providing visual clues to show an emotional style.

8. The method of claim 7, wherein the emotional style further comprises one or more of: an emotion outlook, an extreme emotion, and emotion resilience.

9. A computer program product for monitoring personal emotion states over time from social media, the computer program product comprising a computer readable storage medium having program code embodied therewith, the program code executable by a processor to:
extract personal emotion states from at least one social media data source using a semantic model comprising an integration of numeric emotion measurements and semantic categories;
perform timeline based emotion segmentation with consistent emotional semantics based on the semantic model;
provide, in a visual interface, interactive visual analytics to explore and monitor personal emotional states over time including both a numeric and semantic interpretation of emotions with visual encodings; and
provide visual evidence for analytical reasoning of emotion.

10. The computer program product of claim 9, wherein the semantic model further comprises a combined valance, arousal, dominance (VAD) emotion model and an emotion category model.

11. The computer program product of claim 10, wherein the semantic model is built using a classifier for each emotion category in the emotion category model based on numeric values of the VAD emotion model to predict a basic emotion category, and the program code is further executable by the processor to:
identify words with unknown VAD scores;
determine synonyms with known VAD scores that correspond to each of the words with unknown VAD scores; and
assign a VAD score to each of the words with unknown VAD scores based on an average VAD score of corresponding synonyms.

12. The computer program product of claim 10, wherein the timeline based emotion segmentation further comprises:
defining an emotion distance between the personal emotion states as a weighted sum of a category score and a VAD score;
searching a timeline to identify a top-n number of longest emotion distance scores; and
applying n cuts at time points along the timeline with the top-n number of longest emotion distance scores, thereby grouping similar instances of the personal emotion states together along the timeline.

13. The computer program product of claim 12, wherein the weighted sum of the category score and the VAD score includes a normalization factor to balance contributions of different emotion representations.

14. A system for monitoring personal emotion states over time from social media, the system comprising:
a memory having computer readable computer instructions; and
a processor for executing the computer readable instructions, the computer readable instructions including:
extracting personal emotion states from at least one social media data source using a semantic model comprising an integration of numeric emotion measurements and semantic categories;
performing timeline based emotion segmentation with consistent emotional semantics based on the semantic model;
providing, in a visual interface, interactive visual analytics to explore and monitor personal emotional states over time including both a numeric and semantic interpretation of emotions with visual encodings; and
providing visual evidence for analytical reasoning of emotion.

15. The system of claim 14, wherein the semantic model further comprises a combined valance, arousal, dominance (VAD) emotion model and an emotion category model.

16. The system of claim 15, wherein the semantic model is built using a classifier for each emotion category in the emotion category model based on numeric values of the VAD emotion model to predict a basic emotion category, and further comprising:
identifying words with unknown VAD scores;
determining synonyms with known VAD scores that correspond to each of the words with unknown VAD scores; and
assigning a VAD score to each of the words with unknown VAD scores based on an average VAD score of corresponding synonyms.

17. The system of claim 15, wherein performing timeline based emotion segmentation further comprises:
defining an emotion distance between the personal emotion states as a weighted sum of a category score and a VAD score;
searching a timeline to identify a top-n number of longest emotion distance scores; and
applying n cuts at time points along the timeline with the top-n number of longest emotion distance scores, thereby grouping similar instances of the personal emotion states together along the timeline.

18. The system of claim 17, wherein the weighted sum of the category score and the VAD score includes a normalization factor to balance contributions of different emotion representations.

19. The system of claim 14, wherein providing visual evidence for analytical reasoning of emotion includes one or more of: text summarization, emotion word and original text context view.

20. The system of claim 14, wherein providing visual evidence for analytical reasoning of emotion further comprises providing visual clues to show an emotional style.
